(19) United States
(12) Patent Application Publication
(10) Pub. No.: US 2022/0337649 A1
(43) Pub. Date: Oct. 20, 2022

(54) PRODUCING VEHICLE DATA PRODUCTS USING AN IN-VEHICLE DATA MODEL

(71) Applicant: Wejo Limited, Manchester (GB)

(72) Inventors: Stuart Constantine, Liverpool (GB); Alan Gawthorpe, Sale (GB)

(21) Appl. No.: 17/722,337

(22) Filed: Apr. 16, 2022

Related U.S. Application Data
(60) Provisional application No. 63/176,173, filed on Apr. 16, 2021.

(51) Int. Cl. H04L 65/61; H04W 4/44

(52) U.S. Cl. CPC H04L 65/61; H04W 4/44

(57) ABSTRACT

A data product system and method for generating and providing a data product using data supplied by a multitude of vehicles. The data product system includes in-vehicle data selection computer instructions and a remote data product system storing backend computer instructions. The data product system is configured so that, when the in-vehicle data selection computer instructions are executed at a vehicle, the vehicle: determines whether one or more vehicle conditions are satisfied; and in response to determining that the vehicle condition(s) are satisfied, transmits data item(s) as a second data stream to the remote data repository in place of or in addition to a first data stream. The data product system is configured so that, when the backend computer instructions are executed, the remote data product system generates a first and second data product and provides the first and second data product to a third party computing device.

### TECHNICAL FIELD

This disclosure relates to methods and systems for streaming data from a very large number of vehicles to a remote data repository and generating data products based on the streaming data.

### BACKGROUND

Nowadays, there is a large amount of data streamed from automobiles and other vehicles, and this data is used for various purposes, such as for providing traffic conditions of roads. In many scenarios, vehicles are configured to transmit or stream the same data continuously or periodically to a remote location, such as a remote server.

### SUMMARY

It has been discovered that, depending on one or more conditions or states of a given vehicle, it may be desirable to select certain data items to be transmitted from the vehicle as a part of a data stream.

According to one aspect of the disclosure, there is provided a data product system for generating and providing a data product using data supplied by a multitude of vehicles. Each vehicle has vehicle electronics that include: a plurality of vehicle subsystems each providing data; and a communications subsystem having a wireless communications device and being connected within the vehicle electronics such that the data from the vehicle subsystems is accessible by the communications subsystem, wherein the communications subsystem is configured to: (i) generate a first data stream having data accessed from the vehicle subsystems and transmit the first data stream to a remote data repository; (ii) execute in-vehicle data selection computer instructions that, when executed, cause the communications subsystem to: (a) determine whether one or more vehicle conditions are satisfied, wherein one or more data items and the one or more vehicle conditions are specified by a dynamic data model; and (b) in response to determining that the one or more vehicle conditions are satisfied, transmit the one or more data items as a second data stream to the remote data repository in place of or in addition to the first data stream. The data product system includes the in-vehicle data selection computer instructions and a remote data product system that includes one or more electronic processors and memory storing backend computer instructions, and wherein the data product system is configured so that, when the backend computer instructions are executed by the one or more processors, the data product system: (i) generates a first data product using first repository data that is received from the remote data repository and that includes, or is at least in part based on, at least one data item that is contained in the first data streams received from at least two of the multitude of vehicles; (ii) generates the second data product using second repository data that is received from the remote data repository and that includes, or is at least in part based on, the one or more other data items once the one or more other data items begin to be received by the remote data repository; and (iii) provides the first data product to at least one third party computing device and provides the second data product to the same and/or another third party computing device.

According to various embodiments, the data product system may further include any one of the following features or any technically-feasible combination of some or all of the following features:
the in-vehicle data selection computer instructions, when executed, cause the communications subsystem to select a dynamic data model as the dynamic data model to use for selectively obtaining data to be included in the second data stream;
the one or more vehicle conditions include a condition based on whether a vehicle is within a geographical area;
the one or more vehicle conditions include a condition based on whether a particular event was detected or occurred;
the in-vehicle data selection computer instructions, when executed and in response to determining that the one or more vehicle conditions are satisfied, transmit the one or more data items as the second data stream to the remote data repository in place of the first data stream;
the in-vehicle data selection computer instructions, when executed and in response to determining that the one or more vehicle conditions are satisfied, transmit the one or more data items as the second data stream to the remote data repository in addition to the first data stream;
the in-vehicle data selection computer instructions, when executed, cause the communications subsystem to receive a data model selection indicator that is used to identify which dynamic data model to select as the dynamic data model;
the data model selection indicator is received from a remote computer system, wherein the remote computer system is an original equipment manufacturer (OEM) gateway or the remote data product system, wherein the in-vehicle data selection computer instructions are provided to the multitude of vehicles from the remote computer system or another remote computer system, and wherein each of the multitude of vehicles are configured so that, when the in-vehicle data selection computer instructions are provided to the vehicle electronics, the communications subsystem is configured to execute the in-vehicle data selection computer instructions so as to generate the second data stream; and/or
the data product system is provided by a data product party, wherein the in-vehicle data selection computer instructions are provided by the data product party to one or more manufacturers of the multitude of vehicles, and wherein the in-vehicle data selection computer instructions are provided to the multitude of vehicles via one or more over-the-air messages.

According to another aspect of the disclosure, there is provided a method of generating and providing a data product using data supplied by a multitude of vehicles. The method includes: generating a first data product using first repository data that is received from a remote data repository and that includes, or is at least in part based on, at least one data item that is contained in a first data stream received from at least two of a multitude of vehicles, wherein each of the at least two vehicles is configured to (i) generate the first data stream comprising data accessed from vehicle subsystems and transmit the first data stream to the remote data repository; and (ii) execute in-vehicle data selection computer instructions that, when executed, cause the vehicle to: (a) determine whether one or more vehicle conditions are satisfied, wherein one or more data items and the one or more vehicle conditions are specified by a dynamic data model; and (b) in response to determining that the one or more vehicle conditions are satisfied, transmit the one or more data items as a second data stream to the remote data repository in place of or in addition to the first data stream; generating a second data product using second repository data that is received from the remote data repository and that includes, or is at least in part based on, one or more data items of the second data stream once the one or more data items of the second data stream begin to be received by the remote data repository; and providing the first data product to at least one third party computing device and providing the second data product to the same and/or another third party computing device.

According to various embodiments, the method may further include any one of the following features or any technically-feasible combination of some or all of the following features:
each of the at least two vehicles is a vehicle having vehicle electronics that include: a plurality of vehicle subsystems each providing data; and a communications subsystem having a wireless communications device and being connected within the vehicle electronics such that the data from the vehicle subsystems is accessible by the communications subsystem, wherein the communications subsystem is configured to carry out (i) and (ii);
the in-vehicle data selection computer instructions, when executed, cause the vehicle to select a dynamic data model as the dynamic data model to use for selectively obtaining data to be included in the second data stream;
the one or more vehicle conditions include a condition based on whether a vehicle is within a geographical area;
the one or more vehicle conditions include a condition based on whether a particular event was detected or occurred;
the in-vehicle data selection computer instructions, when executed and in response to determining that the one or more vehicle conditions are satisfied, transmit the one or more data items as the second data stream to the remote data repository in place of the first data stream;
the in-vehicle data selection computer instructions, when executed and in response to determining that the one or more vehicle conditions are satisfied, transmit the one or more data items as the second data stream to the remote data repository in addition to the first data stream;
the in-vehicle data selection computer instructions, when executed, cause the vehicle to receive a data model selection indicator that is used to identify which dynamic data model to select as the dynamic data model;
the data model selection indicator is received from a remote computer system, wherein the remote computer system is an original equipment manufacturer (OEM) gateway or the remote data product system, wherein the in-vehicle data selection computer instructions are provided to the multitude of vehicles from the remote computer system or another remote computer system, and wherein each of the multitude of vehicles are configured so that, when the in-vehicle data selection computer instructions are provided to the vehicle electronics, the communications subsystem is configured to execute the in-vehicle data selection computer instructions so as to generate the second data stream; and/or
the method is carried out by a data product party, wherein the in-vehicle data selection computer instructions are provided by the data product party to one or more manufacturers of the multitude of vehicles, and wherein the in-vehicle data selection computer instructions are provided to the multitude of vehicles via one or more over-the-air messages.

According to one aspect of the disclosure, there is provided a data product system for generating and providing a data product using data supplied by a multitude of vehicles, each vehicle having vehicle electronics that include: a plurality of vehicle subsystems each providing data; and a communications subsystem having a wireless communications device and being connected within the vehicle electronics such that the data from the vehicle subsystems is accessible by the communications subsystem, wherein the communications subsystem is configured to: (i) generate a first data stream comprising data accessed from the vehicle subsystems and transmit the first data stream to a remote data repository; and (ii) execute in-vehicle data selection computer instructions that, when executed, cause the communications subsystem to: (a) determine whether one or more vehicle conditions are satisfied, wherein one or more data items and the one or more vehicle conditions are specified by a dynamic data model; (b) determine an amount of time for transmitting a second data stream; (c) in response to determining that the one or more vehicle conditions are satisfied, transmit the one or more data items as the second data stream to the remote data repository in place of or in addition to the first data stream for the determined amount of time; and (d) after the determined amount of time, end transmission of the second data stream. The data product system comprises the in-vehicle data selection computer instructions and a remote data product system that includes one or more electronic processors and memory storing backend computer instructions, and wherein the data product system is configured so that, when the backend computer instructions are executed by the one or more processors, the data product system: (i) generates a first data product using first repository data that is received from the remote data repository and that includes, or is at least in part based on, at least one data item that is contained in the first data streams received from at least two of the multitude of vehicles; (ii) generates the second data product using second repository data that is received from the remote data repository and that includes, or is at least in part based on, the one or more data items of the second data streams once the one or more data items of the second data streams begin to be received by the remote data repository; and (iii) provides the first data product to at least one third party computing device and provides the second data product to the same and/or another third party computing device.

### BRIEF DESCRIPTION OF THE DRAWINGS

Preferred exemplary embodiments will hereinafter be described in conjunction with the appended drawings, wherein like designations denote like elements, and wherein:

FIG. 1 depicts a communications system that includes a data product system and a plurality of vehicles, according to one embodiment;

FIG. 2 depicts a block diagram of vehicle electronics that may be included in each of the plurality of vehicles of FIG. 1, according to one embodiment;

FIG. 3 depicts a block diagram illustrating components of the communications system of FIG. 1, according to one embodiment;

FIG. 4 is a flowchart of a method of executing in-vehicle data selection computer instructions so as to cause a communications subsystem to transmit one or more data items as a second data stream to a remote data repository, according to one embodiment;

FIG. 5 is a flowchart of a method of generating and providing a data product using data supplied by a multitude of vehicles, according to one embodiment; and

FIG. 6 is a flowchart of a method of transmitting a second data stream to a remote data repository, according to one embodiment.

### DETAILED DESCRIPTION

The system and method described herein enables a vehicle to dynamically-select data to be included in a data stream that is transmitted to a remote data repository and used to generate a data product so as to support the data needs of various data products in a manner that helps minimize the total volume of data transmission and storage required. This is particularly useful for connected vehicles that are configured to capture various data as data items from a variety of mostly in-vehicle data sources, including, for example, image data from cameras, wheel speed data from wheel speed sensors, global navigation satellite system (GNSS) data from a GNSS receiver, other sensor data, as well as driver inputs and settings, etc. The connected vehicles are able to package and transmit at least some of this data to a remote data repository for storage. The collection of this data in real time from a multitude of vehicles (e.g., thousands or millions of vehicles) provides a great deal of information that can be used to create different data products such as real time traffic, weather conditions (e.g., based on windshield wiper operation), and diagnostic information organized by make and model for various vehicle manufacturers (OEMs).

However, it has been discovered that, depending on one or more conditions or states of a given vehicle, it is desirable to select certain data items to be transmitted from the vehicle as a part of a data stream. The systems and methods provided herein enable vehicles to select one or more data items that are to be included in a data stream transmitted from the vehicle to a remote data repository when the one or more vehicle conditions are satisfied. A data product system then generates a data product based on information derived from the data stream as stored at the remote data repository.

As used herein, the following terms have the definitions given. A “data item” is an individual piece of data of any data source type, having more than one possible value and that is implemented in any useful form, such as a number, character string, one or more bits (e.g., a flag/Boolean, a string or array of binary data or bytes), etc. A “data stream” is a continuous, periodic, or intermittent transmission of at least one data item for which the data values might vary between successive transmissions of the data item. A “data source” is a particular originator of data at any suitable level of abstraction, and examples of a data source include, for example, transducers and other sensors, processor-based modules and in-vehicle computer-readable memories, devices such as vehicles and portable connected devices (PCDs) (e.g., smartphones), data repositories, and facilities such as centralized servers. A “data source type” is a generic/subgeneric classification for data that may be included in a data stream from the vehicle based on the type of data source.

As used herein, a “data model” is any representation of data that specifies one or more data items that are to be transmitted as a part of a data stream. As used herein, a “static data model” is any representation of data that specifies one or more data items that are to be transmitted as a part of a data stream without specifying any vehicle conditions that need to be satisfied. As used herein, a “dynamic data model” is any representation of data that specifies one or more vehicle conditions and a data model (or one or more data items) that is/are to be transmitted as a part of a data stream when the one or more vehicle conditions are satisfied. In an exemplary scenario, it may be desirable to receive vehicle data relating to a turn of the vehicle. Thus, according to at least some embodiments, a first data model may specify one or more conditions that, when satisfied, indicate the vehicle is turning or has turned. In such an example, the one or more conditions may be an angle of a steering wheel of the vehicle or an angle of the vehicle wheels relative to a longitudinal axis of the vehicle. The first data model, in this example, also specifies the turn-related data items that may be useful for providing information concerning the turn of the vehicle. In this example, when the vehicle detects the vehicle is turning or has turned, the vehicle may obtain data to be used as (or for generating) the one or more data items. In this example, the one or more data items may be data representing or otherwise pertaining to yaw-rate, steering wheel angle, wheel speed, and wheel slip. This turn-related data may then be streamed or sent to a remote data repository and used to generate a data product, which may include the turn-related data items and/or information derived therefrom, such as whether the turn is considered safe or unsafe.

In one embodiment, data from a vehicle may be divided into two generic classifications: determined data and inputted data. Determined data is data originating from a vehicle subsystem, and inputted data is data originating from a vehicle occupant or an external source, such as a user or another vehicle. Determined data may include the subgeneric classifications of measured (or sensor) data, calculated data, lookup data, and metadata. Inputted data may include the subgeneric classifications of dynamic input data (e.g., driver inputs during a journey), configuration data (e.g., vehicle settings), and externally-source data (e.g., data from other vehicles, roadside equipment, a remote facility or server). The preceding two generic and seven subgeneric data source types are intended to encompass all possible data that can be provided in a data stream from a particular vehicle, but do not need to be considered mutually exclusive of each other. Examples of measured (or sensor) data includes speed, heading, acceleration, deceleration, and battery voltage. Examples of calculated data includes location as calculated by a GNSS receiver, seat occupancy, and battery state of charge. Examples of lookup data include diagnostic trouble codes (DTCs), calibration data, average battery voltage or state of charge, and other data obtained from a lookup table that is stored in memory. Examples of metadata include driver aggressiveness classification, transmission state, and battery system health. Examples of dynamic input data include windshield wiper activation/selection, stability control setting, accelerator and brake pedal inputs, steering inputs, radio volume, and headlight setting. Examples of configuration data include automatic rain sensing, touring/sport mode, max/min startup volume settings, and auto brightness headlights.

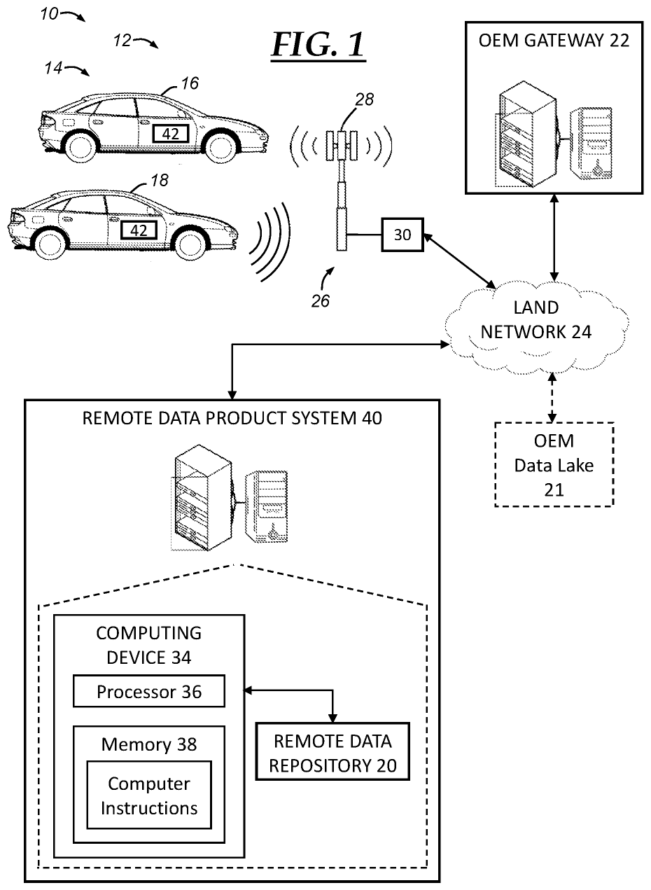

With reference now to FIG. 1, there is shown a communications system 10 that includes a data product system 12 having a remote data product system 40 and in-vehicle data selection computer instructions 42, a plurality of vehicles 14 including a first vehicle 16 and a second vehicle 18, an OEM data lake 21, an OEM gateway 22, a land network 24, and a wireless carrier system 26. Although only two vehicles are shown, it will be appreciated that the system is intended to be capable of working with a multitude of vehicles 14 (i.e., at least 1,000 vehicles) and even with millions of vehicles 14. Also, as used herein, the “vehicles” with which the data product system is used are connected vehicles (CVs) that are capable of wireless communication of data from the vehicle to a data lake or other remote data repository. It should be appreciated that while the illustrated embodiment of FIG. 1 provides an example of one such communications system 10, the data product system 12 and method(s) described below may be used as a part of various other communications systems.

The land network 24 may be a conventional land-based telecommunications network that is connected to one or more landline telephones and connects the wireless carrier system 26 to the data product system 12, the OEM data lake 21, and the OEM gateway 22. For example, the land network 24 may include a public switched telephone network (PSTN) such as that used to provide hardwired telephony, packet-switched data communications, and the Internet infrastructure. One or more segments of the land network 24 could be implemented through the use of a standard wired network, a fiber or other optical network, a cable network, power lines, other wireless networks such as wireless local area networks (WLANs), or networks providing broadband wireless access (BWA), or any combination thereof.

The wireless carrier system 26 may be any suitable cellular telephone system. The wireless carrier system 26 is shown as including a cellular tower 28; however, the wireless carrier system 26 may include additional cellular towers as well as one or more of the following components (e.g., depending on the cellular technology): base transceiver stations, mobile switching centers, base station controllers, evolved nodes (e.g., eNodeBs), mobility management entities (MMEs), serving and PGN gateways, etc., as well as any other networking components used to connect the wireless carrier system 26 with the land network 24 or to connect the wireless carrier system 26 with user equipment (UEs, e.g., which may include telematics equipment in the vehicles 14), all of which is indicated generally at 30. The wireless carrier system 26 may implement any suitable communications technology, including for example GSM/GPRS technology, CDMA or CDMA2000 technology, LTE technology, etc. In general, the wireless carrier system 26, its components, the arrangement of its components, the interaction between the components, etc. is generally known in the art.

The remote data repository 20 is used to store data received from the vehicles 14. For example, the vehicles 14 may each be configured to transmit a first data stream to the remote data repository 20 via the wireless carrier system 26 and the land network 24, and the remote data repository 20, upon receiving the first data stream, may store the data of the first data stream. The remote data repository 20 is shown as a part of the data product system 12, which may be owned and operated by an independent commercial partner of one or more of the vehicle original equipment manufacturers (OEMs). In other embodiments, the data repository may be any publicly or privately accessible aggregation of stored data, which can be structured or unstructured data and which is accessible over a global communications network such as the internet. For example, as optionally shown in FIG. 1, the OEM may have its own data lake (repository) 21 to which the data from the vehicle data streams are initially stored and then accessed (e.g., in real time) by the product data system to generate the first and second data products. However implemented, the remote data repository is remote in the sense that it is remote from the vehicles 14, but in some embodiments may be co-located with the data product system 12 (as shown) and/or with the OEM gateway 22. The remote data repository 20 may be, for example, one or more databases, data lakes, data warehouses, or some combination thereof.

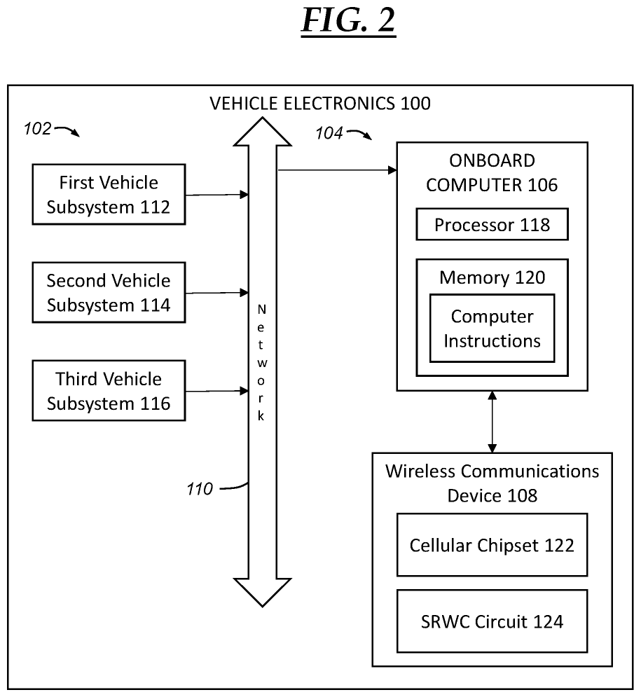

In some embodiments, the OEM may provide the data product system 12 with direct access to the vehicles; for example, by enabling direct streaming of the first and second data streams to the product system 12, rather than via the OEM gateway 22 (and optional OEM data lake 21). This may be done by providing the product data system the necessary credentials and access to the vehicles' communications system 104 (FIG. 2), and techniques for doing that will be known to those skilled in the art. Also, although the discussion herein oftentimes refers to transmitting the first data stream and the second data stream to the remote data repository 20, it should be appreciated that, in other embodiments, either or both of the first data stream and the second data stream may be transmitted to the OEM data lake 21 (or other OEM data repository) and accessed by the data product system 12.

The original equipment manufacturer (OEM) gateway 22 is a computer system that operates as an interface between the vehicles 14 and the remote data product system 40. The OEM gateway 22 may be operated, managed, owned, and/or controlled (collectively “managed”) by an OEM. The OEM gateway 22 may be implemented as computer instructions that are executed by one or more computers or computing devices. In one embodiment, the OEM gateway 22 is configured to receive one or more data models (e.g., dynamic data models, static data models) from the remote data product system 40 and to determine whether to forward those requests to one or more of the vehicles 14. For example, one or more dynamic data models may be sent from the remote data product system 40 to the OEM gateway 22 from the data product system 12. In response, the OEM gateway 22 may determine whether to generate and/or send the one or more data models, or a subset thereof, to one or more vehicles, such as to a subset of vehicles that may be selected either by the OEM gateway 22 or the remote data product system 40. The OEM gateway 22 may implement certain rules or logic to determine whether a particular request from the data product system 12 should or should not be granted, such as whether using one or more data models at a subset of vehicles would cause data used for other systems/applications to not be a part of the stream or whether the requested change would cause a reduction in performance to a level below a predetermined threshold amount or cause an increase in cost to an amount above a predetermine threshold amount.

The data product system 12 includes the remote data product system 40 and the in-vehicle data selection computer instructions 42. The remote data product system 40, which includes the remote data repository 20, is a centralized or distributed computer system that is used to generate one or more data products having or based on data from the remote data repository 20. In at least some embodiments, the data product system 12 (or portions thereof, such as the remote data product system 40) is operated, managed, owned, and/or controlled by a data product party, which is a party that is separate than the OEM that manages the OEM gateway 22. The remote data product system 40 is shown as including a computing device 34 having an electronic processor 36 and computer-readable memory 38. As used herein an “electronic processor” is a physical processing device that operates under electrical power to execute computer instructions. These computer instructions are stored on the computer-readable memory 38, which is accessible by the electronic processor 36 so that the electronic processor 36 may execute the computer instructions stored on the memory 38. Although the remote data product system 40 is illustrated as including a single computing device 34, it should be appreciated that, in other embodiments, the remote data product system 40 includes a plurality of computing devices 34, each of which has an electronic processor and memory. Moreover, in at least some embodiments, the remote data product system 40 may be provisioned or distributed across numerous instances and the functionality described herein as being carried out by the remote data product system 40 may be carried out in a distributed fashion, such as by one or more computing devices that may or may not be co-located with one another. Additionally, it should be appreciated that the computer instructions of the remote data product system 40 may be stored on one or more memories and/or executed by one or more electronic processors, even though FIG. 1 depicts a single electronic processor and memory.

The in-vehicle data selection computer instructions 42 are computer instructions that, when executed by one or more electronic processors of a vehicle, cause the vehicle to: determine whether the one or more vehicle conditions are satisfied; and in response to determining that the one or more vehicle conditions are satisfied, transmit the one or more data items as the second data stream to the remote data repository in place of or in addition to the first data stream. The dynamic data model specifies one or more vehicle conditions and one or more data items that are to be transmitted as a part of a data stream when the one or more vehicle conditions are satisfied. In one embodiment, the in-vehicle data selection computer instructions 42 may be configured at a time of manufacture of the vehicle and, in some embodiments, one or more dynamic data models and a default data model may be stored at the vehicle. In another embodiment, the in-vehicle data selection computer instructions 42 may be deployed to one or more vehicles as a result of one or more over-the-air (OTA) messages or updates. In some embodiments, the in-vehicle data selection computer instructions 42 may be modified or updated to reflect new data models provided from the remote data product system 40. The in-vehicle data selection computer instructions 42, one or more data models, updates or changes to the in-vehicle data selection computer instructions 42, and/or updates or changes to the one or more data models may be provided to the vehicle from the remote data product system 40 directly or via the OEM gateway 22. The in-vehicle data selection computer instructions 42 and the one or more data models may be stored at the vehicle.

In one embodiment, the in-vehicle data selection computer instructions 42 are configured by a data product party and provided by the data product party directly to the vehicles 14, such as via sending the in-vehicle data selection computer instructions 42 from the remote data product system 40 to the vehicles 14. In another embodiment, the in-vehicle data selection computer instructions 42 are configured by a data product party and provided to one or more manufacturers of the vehicles 14, such as one or more OEMs. The OEM(s) may then provide the instructions 42 to the vehicles 14 via the OEM gateway 22 or other remote computer system. In such an embodiment, the data product party may provide the in-vehicle data selection computer instructions 42, or portions thereof, to the OEM, such as to the OEM gateway 22. The OEM(s) may then process the in-vehicle data selection computer instructions 42, such as for purposes of approving the in-vehicle data selection computer instructions 42 for use in the vehicles 14. The OEM(s) may then use the OEM gateway 22 to provide the in-vehicle data selection computer instructions 42 to the vehicles 14, such as by using the wireless carrier system 26 to send one or more OTA messages to the vehicles 14 using, for example, the wireless carrier system 26. In other embodiments, the in-vehicle data selection computer instructions 42 may be developed by the OEM(s) or a third party that is separate from the data product party and the OEM(s). The instructions 42 may be provided from the third party to the vehicle, such as directly from a remote computer system or via the OEM gateway 22 or other remote computer system.

In one embodiment, the in-vehicle data selection computer instructions 42 are downloaded as an in-vehicle application to the vehicle through an application store (or app store) or another digital distribution platform. In one embodiment, the in-vehicle application specifies or includes the in-vehicle data selection computer instructions 42. In some embodiments, data may be streamed from the vehicle to a data repository managed by the data product party and, in such cases, the data may not be first streamed to an OEM computer system, such as the OEM gateway 22. Moreover, in some embodiments, the in-vehicle application may manage one or more data models, including one or more dynamic data models, and this may include, for example, downloading new data models to the vehicle electronics 100 to be used as a part of executing the in-vehicle data selection computer instructions 42 and updating existing data models as stored at the vehicle electronics 100.

The plurality of vehicles 14 includes at least the first vehicle 16 and the second vehicle 18, each of which is depicted in the illustrated embodiment as a passenger car, but it should be appreciated that any other vehicle including motorcycles, trucks, sports utility vehicles (SUVs), recreational vehicles (RVs), other vehicles or mobility devices that can be used on a roadway or sidewalk, boats, other marine vessels, planes, unmanned aerial vehicles (UAVs), other aerial vehicles, etc., can also be used. Although FIG. 1 only depicts two vehicles 16, 18, it should be appreciated that the vehicles 14 may include any number of vehicles. In some embodiments, the data product system 12 is used to generate data products having data aggregated from information concerning a large number of vehicles and, in such embodiments, the communications system 10 may include a multitude of vehicles, which, as used herein, means at least one thousand (1,000) vehicles.

With reference to FIG. 2, there is shown vehicle electronics 100 that may be used as a part of the vehicles 14, including the first vehicle 16 and the second vehicle 18. The vehicle electronics 100 are electronics that include one or more subsystems and/or components that are installed on a vehicle, such as the first vehicle 16 and the second vehicle 18. Although FIG. 2 depicts certain components and subsystems as being a part of the vehicle electronics 100, it should be appreciated that the vehicle electronics 100 may include various other components and/or subsystems in addition to or in lieu of those components and subsystems specifically shown in FIG. 2.

The vehicle electronics 100 includes a plurality of vehicle subsystems 102, a communications subsystem 104 having an onboard computer 106 and a wireless communications device 108, and a communications network 110. The plurality of vehicle subsystems 102 is shown as including a first vehicle subsystem 112, a second vehicle subsystem 114, and a third vehicle subsystem 116; however, it should be appreciated that, in other embodiments, the plurality of vehicle subsystems 102 may include any suitable number of vehicle subsystems. In one embodiment, the first vehicle subsystem 112 is a vehicle positioning subsystem that is used to determine a global navigation satellite system (GNSS) position of the vehicle, such as a geographical positioning system (GPS) position that includes a latitudinal and longitudinal coordinate pair. The second vehicle subsystem 114, at least according to one embodiment, may be a body computer, and the third vehicle subsystem 116 may be an engine controller. Of course, any vehicle subsystem that provides data over the vehicle's bus (e.g., over communications network 110) or that otherwise provides data accessible by the communications subsystem 104 may be used as a data source for data items sent to the remote data repository.

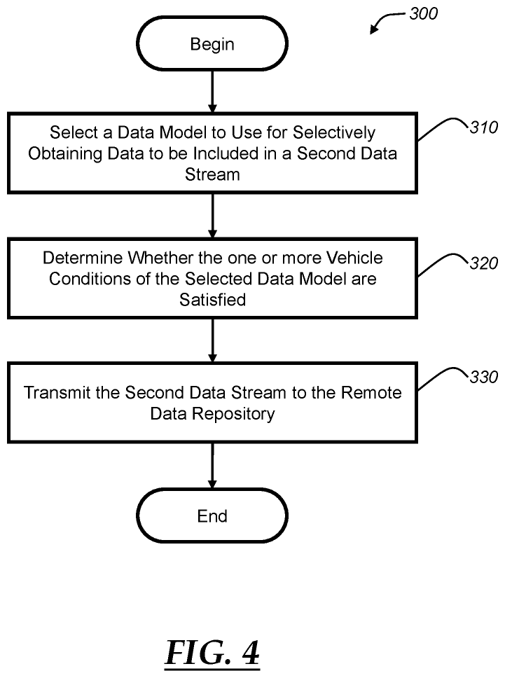

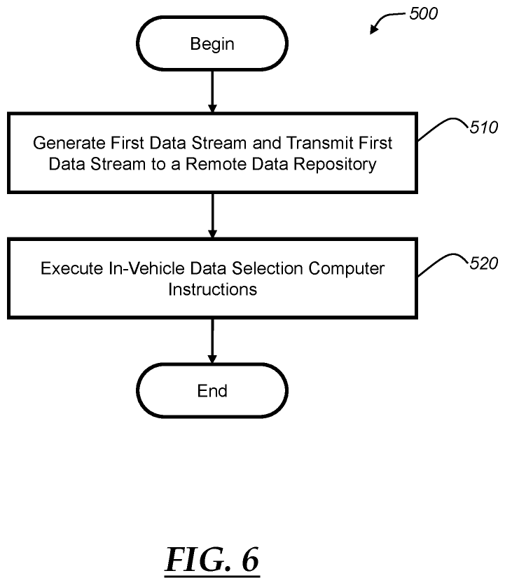

The communications subsystem 104 includes the wireless communications device 108 and is connected within the vehicle electronics 100 such that the data from the vehicle subsystems 102 is accessible by the communications subsystem 104. The communications subsystem 104 is also shown as including the onboard computer 106, which may be used to carry out various processing of the communications subsystem 104, such as that which is described below as being a part of method 300 (FIG. 4) and/or method 500 (FIG. 6). It should be appreciated that, although various processing of the communications subsystem 104 and/or the vehicle electronics 100 is described as being carried out by the onboard computer 106, in one or more embodiments, the processing described herein as being attributed to the onboard computer 106 may be carried out by one or more other computers of the vehicle electronics 100, including those that may or may not be considered as forming a part of the communications subsystem 104. Moreover, although the onboard computer 106 is shown and described as being separate from the wireless communications device 108, in one embodiment, the onboard computer 106 and the wireless communications device 108 are integrated into a single device or module. Also, although the onboard computer 106 and the wireless communications device 108 are illustrated as being directly coupled to one another, in other embodiments, the onboard computer 106 and the wireless communications device 108 may be coupled to each other via the communications network 110 or other suitable electronic communication connection.

The onboard computer 106 includes an electronic processor 118 and computer-readable memory 120 having in-vehicle computer instructions. The memory 120 is operatively coupled to the electronic processor 118 so that the electronic processor 118 may access contents of the memory 120, including the in-vehicle computer instructions. The electronic processor 118 is configured to execute the in-vehicle computer instructions, which, in at least one embodiment, cause the method 500 (FIG. 6) to be carried out. Furthermore, the electronic processor 118, or other processor of the vehicle electronics 100, may be used to execute the in-vehicle data selection computer instructions 42, which causes the communications subsystem 104 to carry out method 300 (FIG. 4).

The wireless communications device 108 is used to provide remote network connectivity to the vehicle electronics 100. The wireless communications device 108 is illustrated as including a cellular chipset 122 and a short range wireless communication (SRWC) circuit 124. However, in other embodiments, the wireless communications device 108 may include only one of a cellular chipset 122 and a SRWC circuit 124. Long-range or remote data communications may be carried out by the wireless communications device 108, such as for purposes of transmitting streaming data to the remote data repository 20. The cellular chipset 122 may be used to provide internet connectivity to the vehicle electronics 100 through establishing communications with the cellular tower 28 of the wireless carrier system 26.

The SRWC circuit 124 enables the vehicle to send and receive wireless messages using one or more SRWC technologies, such as Wi-Fi™, Bluetooth™, IEEE 802.11p, other vehicle to infrastructure (V2I) communications, vehicle to vehicle (V2V) communications, other vehicle to everything (V2X) communications, etc. In one embodiment, the SRWC circuit 124 may be used to connect to a wireless access point hosted by another device, such as a wireless communication device included as a part of roadside equipment or a wireless router located at a vehicle user's residence, which may then provide internet or remote network connectivity. For example, the SRWC circuit 124 may transmit data from the vehicle to the remote data repository via a Wi-Fi™ connection between the wireless communications device 108 and a wireless router/modem, which is then connected to the internet, such as by way of land network 24.

The communications network 110 is an in-vehicle communications network that communicatively couples two or more components or subsystems of the vehicle electronics 100 to each other so that the two or more components may carry out communications. In the illustrated embodiment of FIG. 2, the communications network 110 is shown as communicatively coupling each of the plurality of subsystems 102 to the communications subsystem 104 and, specifically, the onboard computer 106. In one embodiment, the communications network 110 is implemented as one or more hardwired communication network busses, such as those used for providing a controller area network (CAN), a media oriented system transfer (MOST), a local interconnection network (LIN), a local area network (LAN), and/or other appropriate networks, such as those that use Ethernet or others that conform with known ISO, SAE and IEEE standards and specifications, to name but a few. In one embodiment, the communications network 110 may be implemented as a wireless LAN that uses Wi-Fi™, other IEEE 802.11 technology, or other suitable wireless networking technology.

In one embodiment, the onboard computer 106 is configured to obtain certain data communicated over the communications network 110 and, in a particular embodiment, to obtain certain data provided over one or more hardwired communication network busses. The onboard computer 106 may be initially configured to obtain data items that are used to form the first data stream that is transmitted from the vehicle electronics 100 to the remote data repository 20 using the wireless communications device 108. As will be described in more detail below, each of the vehicles 14 may obtain data that is then streamed to the remote data repository 20 as a data stream.

In one embodiment, the onboard computer 106 stores one or more data models. In some embodiments, any one or more of the data models may also include information indicating data streaming parameters, such as the frequency with which the data items are to be captured and/or streamed. In some embodiments, the data streaming parameters may be specific to a particular data item or subset of data items of the one or more data items, or may correspond to the one or more data items of the data model. For example, in one embodiment, the data streaming parameters may specify a first rate of transmission or capture for a first data item and a second rate of transmission or capture for a second data item and, in another embodiment, the data streaming parameters may specify a common or single rate of transmission or capture that is to be used or applied to each of the data item(s) of the data model. The data model(s) may be stored in the memory 120 and accessed by the electronic processor 118, such as during execution of the in-vehicle data selection computer instructions.

In some embodiments, the vehicle electronics 100 may be configured to send a default data stream to the remote data repository 20. In one embodiment, the vehicle electronics 100 transmit the default data stream unless, as a result of executing the in-vehicle data selection computer instructions, a data model other than a default data model is selected. As used herein, a default data model is a data model that is to be used unless another data model is selected. In one embodiment, the default data model is a static data model and, in another embodiment, the default data model is a dynamic data model. In at least some embodiments, the default data model is specified as a part of an initial configuration or provisioning process of the vehicle electronics 100, such as at the time of manufacture of the vehicle or initial sale/lease of the vehicle. Moreover, in some embodiments, the default data model is specified by an OEM of the vehicle as a result of its own volition (i.e., not as a result of a request by a third party) and, in such an embodiment, the default data model may be referred to as an OEM-provisioned data model and the first or default data stream may be referred to as an OEM-provisioned data stream.

Any one or more of the electronic processors discussed herein may be implemented as any suitable electronic hardware that is capable of processing computer instructions and may be selected based on the application in which it is to be used. Examples of types of electronic processors that may be used include central processing units (CPUs), graphics processing units (GPUs), field-programmable gate arrays (FPGAs), application specific integrated circuits (ASICs), microprocessors, microcontrollers, etc. Any one or more of the computer-readable memory discussed herein may be implemented as any suitable type of non-transitory memory that is capable of storing data or information in a non-volatile manner and in an electronic form so that the stored data or information is consumable by the electronic processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It should be appreciated that the computers or computing devices may include other memory, such as volatile RAM that is used by the electronic processor, and/or may include multiple electronic processors.

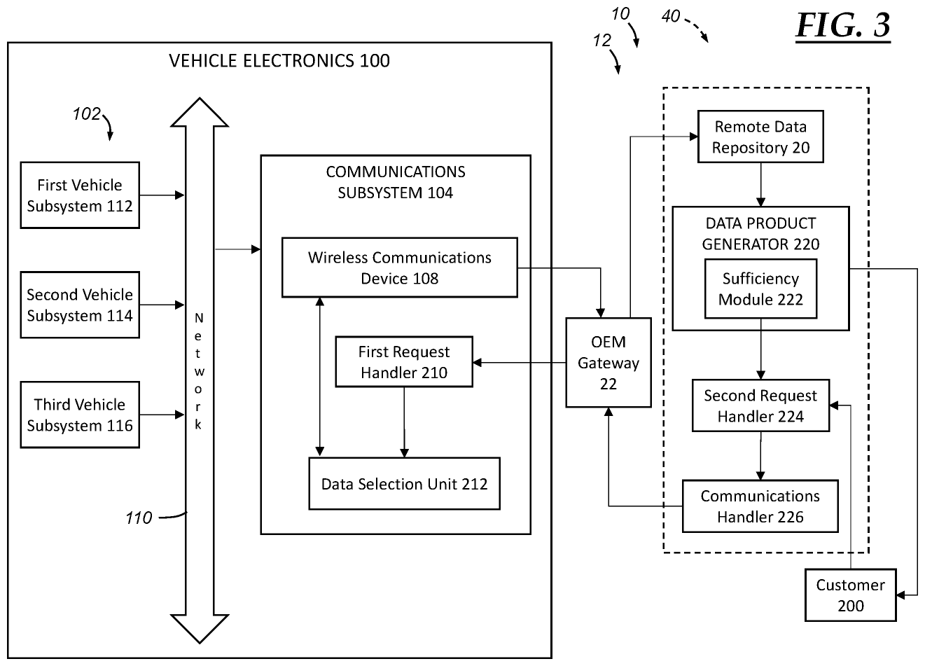

With reference to FIG. 3, there is shown the communications system 10, including the data product system 12, the vehicle electronics 100, the remote data repository 20, the OEM gateway 22, and a data product customer 200. As mentioned above, the vehicle electronics 100 may be used for each, or any suitable subset of, the vehicles 14. The vehicle electronics 100 are shown as including the plurality of vehicle subsystems 102 and the communications subsystem 104. The communications subsystem 104 includes the wireless communications device 108, a first request handler 210, and a data selection unit 212.

The first request handler 210 is a part of the communications subsystem 104 and is used to handle requests received from the OEM gateway 22 and/or the remote data product system 40. Although FIG. 3 shows a communicative connection between the OEM gateway 22 and the first request handler 210, it should be appreciated that the messages may be received at the first request handler 210 via the wireless communications device 108. In at least one embodiment, the first request handler 210 is configured to, in response to receiving a data model update message, make changes to memory of the vehicle electronics 100, such as the memory 120 of the onboard computer 106. In one embodiment, this includes storing a new data model received as a part of the data model update message and/or modifying one or more existing data models stored at the vehicle. Additionally or alternatively, in some embodiments, the first request handler 210 is configured to, in response to receiving an in-vehicle data selection update message, modify the in-vehicle data selection instructions 42, which may include making changes to part of the in-vehicle data selection instructions 42 or completely replacing the in-vehicle data selection instructions 42 with new or updated in-vehicle data selection instructions.

The data selection unit 212 is a part of the communications subsystem 104 and is used to select, or assist in selecting, which data items are to be included as a part of a data stream that is streamed from the vehicle electronics 100 to the remote data repository 20. In one embodiment, the data selection unit 212 is configured to select a data model to use for selectively obtaining data to be included in a second data stream. In at least some embodiments, the data selection unit 212 is configured to determine whether the one or more vehicle conditions are satisfied; and/or, in response to determining whether the one or more vehicle conditions are satisfied, cause the wireless communications device to transmit the one or more data items as the second data stream to the remote data repository in place of the first data stream. In some embodiments, the data selection unit 212 may thus be implemented by executing the in-vehicle data selection computer instructions on one or more electronic processors of the vehicle electronics 100, such as the electronic processor 118. The in-vehicle data selection computer instructions may be stored on any suitable memory of the vehicle electronics 100, such as the memory 120.

Each of the first request handler 210 and the data selection unit 212 may be implemented as executable computer instructions that, when executed by one or more electronic processors of the communications subsystem 104 (e.g., the electronic processor 118 of the onboard computer 106), cause the communications subsystem 104 to carry out the functionality described herein as being attributed to the first request handler 210 or the data selection 212, respectively. That is, for example, the vehicle electronics 100 may include first request handler computer instructions that, when executed, cause the functionality attributed to the first request handler 210 to be carried out.

As is also shown in FIG. 3, the data product system 12 includes the remote data product system 40, which includes a data product generator 220 having a sufficiency module 222, a second request handler 224, and a communications handler 226. The data product generator 220 is used to transform data obtained from the remote data repository 20 into one or more data products, which may then be provided to the data product customer 200. As used herein, a “data product” is data derived or otherwise obtained from a collection of data items streamed as a part of one or more data streams that are transmitted from a group of vehicles to a remote data repository. In some embodiments the data product is containerized or packaged data according to a custom or standardized format or protocol. In one embodiment, various processing may be performed on the data for purposes of obtaining data to be included as a part of the data product. For example, the data product generator 220 may obtain data stored in the remote data repository 20 and perform various processing, such as analytics, on this obtained data so as to generate processed data that is then packaged into a data product. In other embodiments, the data product generator 220 may receive processed data from another device, module, or system that obtains and processes data stored in the remote data repository 20. And, in some embodiments, the data product generator 220 may receive processed data and also carry out further processing on this processed data, the result of which may then be included in the data product.

The data product generator 220 is shown as including the sufficiency module 222, which is used to identify surplus data. The surplus data may comprise one or more data items contained in the first data stream for which the first data product can be generated using the first data stream from a first subset of the plurality of vehicles—that is, the surplus data includes data item(s) that are a part of the first data stream, but that do not need to be received from each of the vehicles providing the first data stream because, for example, obtaining and storing these data item(s) is unnecessary or superfluous. For example, when there are 10,000 vehicles in a particular geographical region that are each sending traffic-related information as a part of the first data stream, it may be determined that the traffic-related information need not be received from each of the 10,000 vehicles, but that the traffic-related information should be received from only 2,000 of the 10,000 vehicles since such information from 2,000 vehicles is sufficient and such information from the other 8,000 vehicles is not needed or redundant. In such an instance, the first subset of vehicles corresponds to the 2,000 vehicles and the remaining 8,000 vehicles corresponds to a second subset of vehicles. In this example, the surplus data includes those data items that provide the traffic-related information. The remote data product system 40 may determine that a new or updated data model is to be sent to the second subset of vehicles, and the new or updated data model may be configured based on or in response to the surplus data. The sufficiency module 222 is shown in FIG. 3 as being a part or portion of the data product generator 220; however, it should be appreciated that the sufficiency module 222 may be implemented as a separate and distinct module that is communicatively coupled to the remote data repository 20, the data product generator 220, or another device or system that provides information to the sufficiency module regarding the data stored in the remote data repository 20 that is suitable for use in identifying the surplus data.

The surplus data may comprise specific data items from the first data stream that are not needed at the moment for any data product, or possibly not currently needed for any purpose at all, and can be excluded from the second (modified) data streams coming from the second subset of vehicles. Alternatively or additionally, the surplus data may comprise data supplied in the first data stream at a frequency in excess of that needed to produce the first data product, such that the streaming data change request may specify a longer period between occurrences of the data item in the stream, thereby lowering the total data transmission volume such that the additional data items needed for the second data product may be included with minimal or no increase to the total volume of data transmitted. In this way the product data system achieves increased efficiency in operation—by enabling it to generate additional data products without a concomitant increase in the total data volume transmitted from the vehicles individually and as a group.

In a like manner, the additional data needed for the second data product may comprise particular data items not contained at all in the first data stream, and/or may comprise existing data items in the first data stream for which a higher frequency of updates are needed. As examples, in the event of adverse weather that might affect drivability of roads in a particular geographic region (e.g., snow/sleet/ice accumulation from a storm), data not normally transmitted in the first data stream might be needed or desired to generate a (second) data product that provides more accurate/targeted information concerning driving conditions. This may include data items not normally sent concerning operator inputs such as windshield wiper activation, window defrost activation, climate control (e.g., max defrost fan) settings, selected vehicle gear/transmission settings. Alternatively or additionally, this may include data items that are included in the first data stream, but at a rate that is less than desired or needed for the second data product, such as transmission system data (e.g., wheel slip) or lateral accelerations (e.g., indicative of sliding). Some or all of this additional data may be identified in the data stream change request so that they are included in the second (modified) data stream in place of at least some of the surplus data that was being sent in the original (first) data stream.

In one embodiment, in addition to identifying the surplus data, the sufficiency module 222, or other portion of the remote data product system 40, may determine vehicle selection data that specifies a subset of vehicles. The vehicle selection data may include vehicle selection parameters or vehicle identification data. The vehicle selection parameters are parameters used to specify a subset of vehicles without uniquely identifying any of the vehicles in the subset of vehicles, and the vehicle identification data is data or information uniquely specifying each vehicle of a subset of vehicles.

The second request handler 224 is a part of the remote data product system 40 and is communicatively coupled to the sufficiency module 222. The second request handler 224 is responsive to identification of the surplus data and to data product request data. In one embodiment, the second request handler 224 receives data identifying the data items of the surplus data and the vehicle selection data from the sufficiency module 222. The data product request data may be data indicating one or more data items that are to be included in a data product that is requested by the data product customer 200, such as the second data product. The data product request data may be provided to the second request handler 224 directly from the data product customer 200, such as through an application programming interface (API), or may be provided from the data product customer 200 to a person of the party managing the data product system 12. In the latter case, the person may input the data product request data into the remote data product system 40 such that it is accessible by the second request handler 224.

The communications handler 226 is used to initiate requests to one or more vehicles, such as one or more data model update requests for the second subset of vehicles. The one or more data model update requests may each specify one or more new data models or updates to one or more existing data models stored at a vehicle, and these data model update requests may be sent to the OEM gateway 22. The OEM gateway 22 may then determine whether to forward the new data model(s) or data model updates to the vehicles. The data model update requests may be compiled by the communications handler 226 into one or more electronic messages, which are then sent to the OEM gateway 22. In another embodiment, the communications handler 226 may send the data model update requests to the second subset of vehicles without sending or having to send the data model update requests to the OEM gateway 22.

Each of the data product generator 220, the sufficiency module 22, the second request handler 224, and the communications handler 226 may be implemented as executable computer instructions that, when executed by one or more electronic processors of the remote data product system 40 (e.g., the electronic processor 36 of the computing device 34), cause the remote data product system 40 to carry out the functionality described herein as being attributed to the data product generator 220, the sufficiency module 22, the second request handler 224, and the communications handler 226, respectively. That is, for example, the remote data product system 40 may include data product generator computer instructions that, when executed, cause the functionality attributed to the data product generator 220 to be carried out.

In one example, the first data product is responsive to a generalized set of vehicle data in the first data stream and supports a first data product, such as generalized traffic intelligence information about vehicle road speeds, road densities, parking densities, travel times between major points, etc. The data product system 12 may, in response to an external weather forecast data, provide a request for enhanced environmental sensor information from a subset of vehicles in a designated geographical area. The second request handler 224 arbitrates this request by considering whether the designated geographical area has sufficient density of connected vehicles to send a request through the communications handler 226 to reassign a subset of the vehicles in the designated geographical area to send the enhanced environmental sensor data in lieu of at least some of the first data stream. Alternatively, the arbitration by the second request handler 224 may attach a relative weight to consider the importance or priority of the request. The OEM gateway 22 sends the responsive communications to the appropriate vehicle subset of connected vehicles 14. In an example, the data for the second data stream is already available on a vehicle data bus and accessible by the communications subsystem 104. The data selection unit 212 executes instructions directing the communications subsystem 104 to read the enhanced environmental sensor data from the vehicle data bus for transmission as the second data stream, which is sent using the wireless communications device 108. In an example, the enhanced environmental data may be processed, interpreted, normalized, or subject to other operations the results of which are included in the transmission of the second data stream along with or in lieu of the raw vehicle data bus data. Through the process described above, a subset of the connected vehicles in the designated geographic area begin to transmit a second data stream that traverses communications channels as described above to the data product system 12, which uses the data to provide a weather-based data product.

In another example, the data product system 12 may request data in response to an external request from a supplier of modules that were installed by one or more vehicle original equipment manufacturers into at least a portion of the vehicles 14. This request may be for output, performance, or diagnostic data produced by or related to the modules from the supplier. This request may come from an external interface into system 12 or may come from a data product module within the data product system 12 responsive to a prior data product purchase arrangement between the operator of the data product system 12 and the supplier. As described above, the second request handler 224 arbitrates this request, including selecting a vehicle set or a vehicle criteria that can provide the data meeting the request, and sends the required communications through the communications handler 226. The OEM gateway 22 sends the responsive communications to the appropriate subset of vehicles 14. In this example a subset of the vehicles begin to transmit the second data stream that contains the module output, performance, and/or diagnostic data. This data stream traverses communications channels as described above to the data product system 12, which uses the data to provide a module performance data product to the supplier. The supplier may utilize this data for a variety of purposes, including, for example, to determine the performance of the module, determine whether a group of modules could benefit from a software update, or to support a service associated with the module. An advantage of this example is the potential for suppliers of vehicle components to request information about components already in production, which can be satisfied through data products added to the data product system 12.

With reference to FIG. 4, there is shown an embodiment of a method 300 of executing in-vehicle data selection computer instructions so as to cause a communications subsystem to transmit the one or more data items as a second data stream to a remote data repository. According to at least some embodiments, the method 300 is carried out by one or more electronic processors of the vehicle electronics 100, such as the electronic processor 118. And, in one embodiment, the method 300 is carried out by the communications subsystem 104 and, in particular, by the data selection unit 212. Although the steps of the method 300 are described as being carried out in a particular order, it should be appreciated that the steps of the method 300 may be carried out in any technically-feasible order.

The method 300 begins with step 310, wherein a dynamic data model to use for selectively obtaining data to be included in a second data stream is selected. The dynamic data model specifies one or more vehicle conditions and one or more data items. The vehicle electronics 100 may store, such as in the memory 120, one or more dynamic data models. The data selection unit 212 may determine whether to select a particular dynamic data model based on one or more data model selection parameters. The data model selection parameters may specify one or more conditions, such as one or more vehicle conditions, that are used to select the dynamic data model. For example, a first data model selection parameter may specify a particular geographical region and an associated dynamic data model so that, when it is determined that the vehicle is within the geographical region, the associated dynamic data model is selected. As another example, a second data model selection parameter may specify one or more time or date ranges (e.g., 1:00 to 6:00, April 1 through April 15) and an associated dynamic data model so that, when it is determined that the present time of day or date is within the specified range, the associated dynamic data model is selected. Various other data model selection parameters may be used. In some embodiments, two or more dynamic data models are selected and the one or more data items of each of the dynamic data items may together form the second data stream. In such embodiments, the steps 320 through 330 may be carried out for or with respect to each of the selected dynamic data models.

In some embodiments, the dynamic data model may be selected in response to receiving a data model selection indicator from the OEM gateway 22 and/or the remote data product system 40. The data model selection indicator may then be used by the vehicle to identify which dynamic data model to select. In other embodiments, step 310 is omitted and the vehicle electronics are preprogrammed to use a particular dynamic data model. The method 300 continues to step 320.

In step 320, it is determined whether the one or more vehicle conditions are satisfied. The one or more vehicle conditions are those specified by the dynamic data model that was selected in step 310. The one or more vehicle conditions may specify a state of one or more subsystems or components of the vehicle, such as a particular voltage range of a vehicle battery (e.g., below 10V), an environmental condition of the vehicle (e.g., precipitation such as rain is detected at the vehicle, the vehicle is located within a defined geographical region), an operating condition of the vehicle (e.g., an ignition on for a predetermined amount of time, vehicle speed reaches a threshold amount), whether a particular event (e.g., a turn of the vehicle, hard brake event) was detected or occurred, etc. This vehicle state information may originate from one or more of the plurality of subsystems 102 of the vehicle electronics 100. In one embodiment, the vehicle electronics 100 monitors for whether the one or more conditions have been satisfied by monitoring data communicated over the communications network 110 and analyzing or interrogating the data to determine whether the data indicates the presence of the one or more vehicle conditions.

As an example, a first data model may specify one or more conditions that, when satisfied, indicate the vehicle is turning or has turned. In such an example, the one or more conditions may be an angle of a steering wheel of the vehicle or an angle of the vehicle wheels relative to a longitudinal axis of the vehicle. The communications subsystem 104 may monitor the communications network 110 for steering wheel angle data and then compare a steering wheel angle as indicated by the steering wheel angle data to a threshold as specified by a condition of the one or more conditions. The same may be true for the angle of the vehicle wheels, for example. When it is detected that the one or more vehicle conditions have been satisfied, the method 300 continues to step 330.

In step 330, in response to determining that the one or more vehicle conditions are satisfied, the one or more data items are transmitted as the second data stream to the remote data repository. According to various embodiments, the second data stream may be transmitted in place of or in addition to the first data stream. In one embodiment, this step includes obtaining the one or more data items from the communications network 110 and then packaging the one or more data items into one or more electronic messages that are then provided to the wireless communications device 108, which then transmits the one or more electronic messages. In another embodiment, the data selection unit 212 provides information to another component of the communications subsystem 104 that indicates the one or more data items to be included in the second data stream that is sent to the remote data repository 20.

In continuing with the example discussed in step 320, when the vehicle detects the vehicle is turning or has turned (step 320), the vehicle may obtain data to be used as (or for generating) the one or more data items. In this example, the one or more data items may be data representing or otherwise pertaining to yaw-rate, steering wheel angle, wheel speed, and wheel slip. This turn-related data may be obtained from the communications network 110 and then packaged into one or more messages for transmission.

In at least some embodiments, an amount of time for transmitting a second data stream is determined. For example, the selected data model or portion thereof may be associated with a predetermined amount of time, such as five seconds, three minutes, or one day, which may be used as indicating the amount of time to transmit the second data stream upon the vehicle conditions being satisfied. Thus, in some embodiments, the predetermined amount of time may be associated (or pre-associated) with the one or more vehicle conditions. In another embodiment, the amount of time may be determined based on a vehicle state, such as vehicle speed, vehicle position, etc., or even the vehicle condition(s) (or information/data related to the vehicle condition(s)). The second data stream is transmitted for the determined amount of time and, after this amount of time, the transmission of the second data stream is ended. The method 300 then ends.

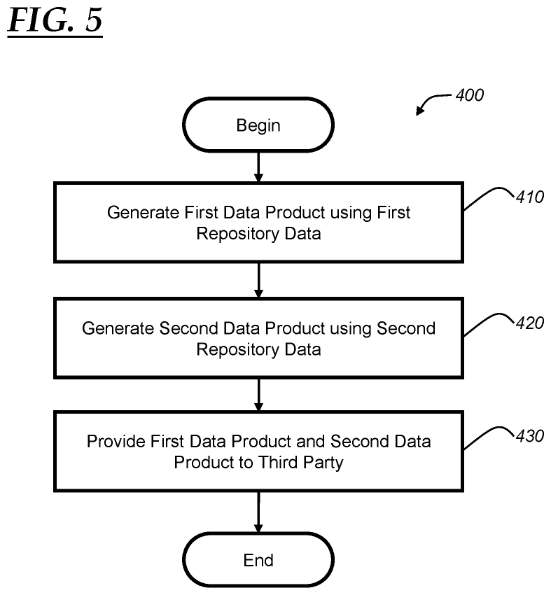

With reference to FIG. 5, there is shown an embodiment of a method 400 of generating and providing a data product using data supplied by a multitude of vehicles. According to at least some embodiments, the method 400 is carried out by the remote data product system 40 and, in particular, the remote data product system 40 includes one or more electronic processors (including the electronic processor 36) that are configured to execute computer instructions that, when executed by the one or more electronic processors, cause the remote data product system 40 to carry out the method 400. Although the steps of the method 400 are described as being carried out in a particular order, it should be appreciated that the steps of the method 400 may be carried out in any technically-feasible order.

The method 400 begins with step 410, wherein a first data product is generated using first repository data that is received from the remote data repository. The first repository data includes, or is at least in part based on, at least one data item that is contained in the first data streams received from at least some of the multitude of vehicles. In one embodiment, the data product generator 220 obtains data that was stored at the remote data repository 20 as a result of the first data streams from the multitude of vehicles and then processes the obtained data to generate the first data product. In another embodiment, the data that was stored at the remote data repository 20 as a result of the first data stream may first be processed, such as for calculating analytics describing the data, by another device or system before it is received at the data product generator 220. The method 400 continues to step 420.

In step 420, the second data product is generated using second repository data that is received from the remote data repository. The second repository data includes, or is at least in part based on, the one or more data items of the second data stream once these one or more other data items begin to be received by the remote data repository. This step may be carried out in the same or a similar manner as step 410, except that second repository data is used to generate the second data product. The method 400 continues to step 430.

In step 430, the first data product and the second data product are provided to at least one third party computing device (e.g., a third party's server, data repository, client device, or portable connected device). In one embodiment, the first data product and second data product are provided to the same third party computing device, such as for purposes of providing both data products to a single customer. In another embodiment, the first data product may be sent or otherwise provided to a first third party computing device associated with a first data product customer, and the second data product may be sent or otherwise provided to a second third party computing device associated with a second data product customer that is different than the first data product customer. In one embodiment, the data product system 12 transmit the data products to the third party computing device or, in another embodiment, the data product system 12 provides a download link to the third party computing device that is usable to access and download the data products. The method 400 then ends.

With reference to FIG. 6, there is shown an embodiment of a method 500 of transmitting a second data stream to a remote data repository. The method 500 is carried out by vehicle electronics and, in particular and at least according to some embodiments, by the communications subsystem 104 of the vehicle electronics 100. Although the steps of the method 500 are described as being carried out in a particular order, it should be appreciated that the steps of the method 500 may be carried out in any technically-feasible order.

The method 500 begins with step 510, wherein first data stream is generated and transmitted to a remote data repository. The first data stream comprises data accessed from the vehicle subsystems. In one embodiment, the first data stream may be a default data stream that includes one or more data items that are transmitted to the remote data repository 20. The data selection unit 212 may be used to indicate which data items to include as a part of the first data stream. For example, in one embodiment, a first data model indicating one or more data items to be included in the first data stream may be provided by the data selection unit 212. The communications subsystem 104, such as through use of the onboard computer 106, may then obtain the data items from one or more of the plurality of vehicle subsystems 102 and transmit the obtained data items to the remote data repository 20. The method 500 continues to step 520.

In step 520, in-vehicle data selection computer instructions are executed. The in-vehicle data selection computer instructions may be executed by the communications subsystem 104, such as by the electronic processor 118 of the onboard computer 106 and/or by one or more other electronic processors of the communications subsystem 104. In other embodiments, the in-vehicle data selection computer instructions may be executed by one or more other electronic processors of the vehicle, such as those that are not a part of the communications subsystem 104. The method 300 describes a process that is carried out as a result of executing the in-vehicle data selection computer instructions at the vehicle electronics 100, at least according to one embodiment.

As a result of executing the in-vehicle data selection computer instructions, the communications subsystem 104 causes the second data stream to be transmitted to the remote data repository in place of or in addition to the first data stream. In some embodiments where the second data stream is transmitted in place of the first data stream, after the first data stream is modified into the second data stream, the communications subsystem 104 may then begin to generate the second data stream and then transmit the second data stream to the remote data repository 20, at least according to some embodiments. In at least one embodiment, the second data stream, which includes the other data items that are/were not contained in the first data stream, is transmitted in addition to or in place of the first data stream.

In some embodiments, the second data stream may be provided as a data stream that is separate from the first data stream. In such an embodiment, for example, the second data stream and the first data stream may both be transmitted from the vehicle. In one embodiment, however, as a part of executing the in-vehicle data selection computer instructions, the first data stream may be modified, such as to remove those data items indicated as being unnecessary or superfluous as represented by surplus data that may be provided to the vehicle. In such an embodiment, the first data stream, as modified, may be transmitted to the remote data repository along with the second data stream that is separate from the first data stream and that includes one or more data items not included in the first data stream. In another embodiment, the second data stream may be the first data stream as modified in response to executing the in-vehicle data selection computer instructions, which may result in further including one or more data items as specified by the selected dynamic data model and/or excluding one or more data items contained in the first data stream. In some embodiments, the selected dynamic data model may indicate one or more data items of the first data stream that are to be excluded from either the first data stream (such as in cases where the first data stream is sent in addition to the second data stream) or the second data stream (such as in cases where the second data stream is sent in place of the first data stream).

The communications subsystem 104 may transmit the second data stream using the wireless communications device 108. For example, the second data stream may be transmitted from the cellular chipset 122 of the wireless communications device 108 to the remote data repository 20 via the wireless carrier system 26 and the land network 24. The method 500 then ends.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A data product system for generating and providing a data product using data supplied by a multitude of vehicles, each vehicle having vehicle electronics that comprise:
a plurality of vehicle subsystems each providing data; and
a communications subsystem having a wireless communications device and being connected within the vehicle electronics such that the data from the vehicle subsystems is accessible by the communications subsystem, wherein the communications subsystem is configured to:
generate a first data stream comprising data accessed from the vehicle subsystems and transmit the first data stream to a remote data repository; and
execute in-vehicle data selection computer instructions that, when executed, cause the communications subsystem to:
determine whether one or more vehicle conditions are satisfied, wherein one or more data items and the one or more vehicle conditions are specified by a dynamic data model; and
in response to determining that the one or more vehicle conditions are satisfied, transmit the one or more data items as a second data stream to the remote data repository in place of or in addition to the first data stream; and
wherein the data product system comprises the in-vehicle data selection computer instructions and a remote data product system that includes one or more electronic processors and memory storing backend computer instructions, and wherein the data product system is configured so that, when the backend computer instructions are executed by the one or more processors, the data product system:
generates a first data product using first repository data that is received from the remote data repository and that includes, or is at least in part based on, at least one data item that is contained in the first data streams received from at least two of the multitude of vehicles;
generates the second data product using second repository data that is received from the remote data repository and that includes, or is at least in part based on, the one or more data items of the second data streams once the one or more data items of the second data streams begin to be received by the remote data repository; and
provides the first data product to at least one third party computing device and provides the second data product to the same and/or another third party computing device.

2. The data product system of claim 1, wherein the in-vehicle data selection computer instructions, when executed, cause the communications subsystem to select a dynamic data model as the dynamic data model to use for selectively obtaining data to be included in the second data stream.

3. The data product system of claim 1, wherein the one or more vehicle conditions include a condition based on whether a vehicle is within a geographical area.

4. The data product system of claim 1, wherein the one or more vehicle conditions include a condition based on whether a particular event was detected or occurred.

5. The data product system of claim 1, wherein the in-vehicle data selection computer instructions, when executed and in response to determining that the one or more vehicle conditions are satisfied, transmit the one or more data items as the second data stream to the remote data repository in place of the first data stream.

6. The data product system of claim 1, wherein the in-vehicle data selection computer instructions, when executed and in response to determining that the one or more vehicle conditions are satisfied, transmit the one or more data items as the second data stream to the remote data repository in addition to the first data stream.

7. The data product system of claim 1, wherein the in-vehicle data selection computer instructions, when executed, cause the communications subsystem to receive a data model selection indicator that is used to identify which dynamic data model to select as the dynamic data model.

8. The data product system of claim 7, wherein the data model selection indicator is received from a remote computer system, wherein the remote computer system is an original equipment manufacturer (OEM) gateway or the remote data product system, wherein the in-vehicle data selection computer instructions are provided to the multitude of vehicles from the remote computer system or another remote computer system, and wherein each of the multitude of vehicles are configured so that, when the in-vehicle data selection computer instructions are provided to the vehicle electronics, the communications subsystem is configured to execute the in-vehicle data selection computer instructions so as to generate the second data stream.

9. The data product system of claim 7, wherein the data product system is provided by a data product party, wherein the in-vehicle data selection computer instructions are provided by the data product party to one or more manufacturers of the multitude of vehicles, and wherein the in-vehicle data selection computer instructions are provided to the multitude of vehicles via one or more over-the-air messages.

10. A method of generating and providing a data product using data supplied by a multitude of vehicles, comprising:
generating a first data product using first repository data that is received from a remote data repository and that includes, or is at least in part based on, at least one data item that is contained in a first data stream received from at least two of a multitude of vehicles, wherein each of the at least two vehicles is configured to (i) generate the first data stream comprising data accessed from vehicle subsystems and transmit the first data stream to the remote data repository; and (ii) execute in-vehicle data selection computer instructions that, when executed, cause the vehicle to: (a) determine whether one or more vehicle conditions are satisfied, wherein one or more data items and the one or more vehicle conditions are specified by a dynamic data model; and (b) in response to determining that the one or more vehicle conditions are satisfied, transmit the one or more data items as a second data stream to the remote data repository in place of or in addition to the first data stream;
generating a second data product using second repository data that is received from the remote data repository and that includes, or is at least in part based on, one or more data items of the second data stream once the one or more data items of the second data stream begin to be received by the remote data repository; and
providing the first data product to at least one third party computing device and providing the second data product to the same and/or another third party computing device.

11. The method of claim 10, wherein each of the at least two vehicles is a vehicle having vehicle electronics that include:
a plurality of vehicle subsystems each providing data; and
a communications subsystem having a wireless communications device and being connected within the vehicle electronics such that the data from the vehicle subsystems is accessible by the communications subsystem, wherein the communications subsystem is configured to carry out (i) and (ii).

12. The method of claim 10, wherein the in-vehicle data selection computer instructions, when executed, cause the vehicle to select a dynamic data model as the dynamic data model to use for selectively obtaining data to be included in the second data stream.

13. The method of claim 10, wherein the one or more vehicle conditions include a condition based on whether a vehicle is within a geographical area.

14. The method of claim 10, wherein the one or more vehicle conditions include a condition based on whether a particular event was detected or occurred.

15. The method of claim 10, wherein the in-vehicle data selection computer instructions, when executed and in response to determining that the one or more vehicle conditions are satisfied, transmit the one or more data items as the second data stream to the remote data repository in place of the first data stream.

16. The method of claim 10, wherein the in-vehicle data selection computer instructions, when executed and in response to determining that the one or more vehicle conditions are satisfied, transmit the one or more data items as the second data stream to the remote data repository in addition to the first data stream.

17. The method of claim 10, wherein the in-vehicle data selection computer instructions, when executed, cause the vehicle to receive a data model selection indicator that is used to identify which dynamic data model to select as the dynamic data model.

18. The method of claim 17, wherein the data model selection indicator is received from a remote computer system, wherein the remote computer system is an original equipment manufacturer (OEM) gateway or the remote data product system, wherein the in-vehicle data selection computer instructions are provided to the multitude of vehicles from the remote computer system or another remote computer system, and wherein each of the multitude of vehicles are configured so that, when the in-vehicle data selection computer instructions are provided to the vehicle electronics, the communications subsystem is configured to execute the in-vehicle data selection computer instructions so as to generate the second data stream.

19. The method of claim 17, the method is carried out by a data product party, wherein the in-vehicle data selection computer instructions are provided by the data product party to one or more manufacturers of the multitude of vehicles, and wherein the in-vehicle data selection computer instructions are provided to the multitude of vehicles via one or more over-the-air messages.

20. A data product system for generating and providing a data product using data supplied by a multitude of vehicles, each vehicle having vehicle electronics that comprise:
a plurality of vehicle subsystems each providing data; and
a communications subsystem having a wireless communications device and being connected within the vehicle electronics such that the data from the vehicle subsystems is accessible by the communications subsystem, wherein the communications subsystem is configured to:
generate a first data stream comprising data accessed from the vehicle subsystems and transmit the first data stream to a remote data repository; and
execute in-vehicle data selection computer instructions that, when executed, cause the communications subsystem to:
determine whether one or more vehicle conditions are satisfied, wherein one or more data items and the one or more vehicle conditions are specified by a dynamic data model;
determine an amount of time for transmitting a second data stream;
in response to determining that the one or more vehicle conditions are satisfied, transmit the one or more data items as the second data stream to the remote data repository in place of or in addition to the first data stream for the determined amount of time; and
after the determined amount of time, end transmission of the second data stream;
wherein the data product system comprises the in-vehicle data selection computer instructions and a remote data product system that includes one or more electronic processors and memory storing backend computer instructions, and wherein the data product system is configured so that, when the backend computer instructions are executed by the one or more processors, the data product system:
generates a first data product using first repository data that is received from the remote data repository and that includes, or is at least in part based on, at least one data item that is contained in the first data streams received from at least two of the multitude of vehicles;
generates the second data product using second repository data that is received from the remote data repository and that includes, or is at least in part based on, the one or more data items of the second data streams once the one or more data items of the second data streams begin to be received by the remote data repository; and
provides the first data product to at least one third party computing device and provides the second data product to the same and/or another third party computing device.
